(19) United States
(12) Patent Application Publication
(10) Pub. No.: US 2007/0257987 A1
(43) Pub. Date: Nov. 8, 2007

(54) Gun incident recording device

(76) Inventor: Bal Wang, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/709,884

(22) Filed: Feb. 23, 2007

(30) Foreign Application Priority Data
Mar. 30, 2006 (TW) 095111097

(51) Int. Cl. H04N 7/18; G06F 17/00

(52) U.S. Cl. 348/158; 348/143; 340/540

(57) ABSTRACT

The present invention provides a gun incident recording device able to preserve a video recording of when a shooting device was used and the course of events, and includes an actuating device, an image sensor, a data processor, an optical detector and an event sensor device. The actuating device detects use mode of the shooting device, and as soon as an attempt is made to use the shooting device, then the actuating device actuates the image sensor to commence video recording, and once the shooting device is fired or there is an irregular jerking movement or sound, then the event sensor device transmits instructions to the data processor to lock the video recording for a predetermined period of time covering before and after the event occurred, and providing evidence for use during later review and verification of the event when the shooting device was used.

### BACKGROUND OF THE INVENTION

(a) Field of the Invention

The present invention provides a gun incident recording device having a simple structure, is easy to operate, small in size and does not occupy space, which can be disposed on a shooting device and video record events when using a gun.

(b) Description of the Prior Art

At present, crime is on the rise worldwide, and burglary by so-called night prowlers and thieves has evolved into the audacious behavior of armed robbery, holdups and murder by rampant gangsters with no regard for law and order, and represents a decadent symbol of the social climate, which has resulted in indiscriminate use of firearms by criminals. Hence, police often cannot but use firearms to confront and capture felons, particularly the criminals who possess guns and defy police orders.

However, when facing criminals having complete disregard for law and order, police must be especially cautious when using a gun, on the one hand paying particular attention to the ruthless indiscriminate shooting by criminals, and on the other hand being cautious when using the gun to return fire to ensure abidance to the law and guaranteeing the rights of the criminals. Such a situation places many restrictions on police, and police come under review as to whether use of the gun was correct or not once a criminal has been killed by return fire, and may meet with prosecution. The issue regarding use of firearms by the police for self-defense is often raised for discussion in social news. However, how can it be proved that police use guns as justifiable defense or justifiable return of fire? Because there is no actual evidence, and it is not possible to return to the real situation at the time the incident occurred, thus, the incident is simulated. However, because of the many interpretations to explain the incident, thus, it is difficult to obtain a clear understanding of the real situation. Were guns used in anger, willfully or legitimately? Such an issue often becomes the focal point of the argument for the police implicated, and the topic for discussion for the media. Contention between guaranteeing human rights and police law enforcement has hitherto resulted in the inability to effectively achieve mutual recognition.

### SUMMARY OF THE INVENTION

A gun incident recording device of the present invention is able to commence video recording of an incident as soon as a person uses a gun, moreover, s soon as firing begins or there is an irregular jerking movement, then the video recording for the specified time period covering before and after an incident has occurred is locked, thereby eliminating the possibility of it being overwritten or accidentally erased, and facilitating retaining a complete record of the gun incident for use as evidence during a review of the case.

The gun incident recording device of the present invention is fixed to a shooting device, and when a police officer is on duty, as soon as he takes the shooting device out from a holster or attempts to use the shooting device, then it is regarded as an intention to use the shooting device and an actuating device actuates an image sensor to commence video recording, whereafter shooting, a vibratory movement or sound causes an event sensor device to transmit a message to a data processor to lock the contents of video recorded for a specified predetermined period of time covering before and after the incident occurred, thereby providing evidence for use during later review and verification of the event when the shooting device was used.

The gun incident recording device of the present invention further enables an officer in charge to understand the situation at the time an incident occurs by remotely controlling actuation of a wireless transmitter device, thereby enabling transmitting the on-scene situation to a specified location for viewing thereof.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a block schematic diagram depicting operation of the present invention.

FIG. 2 shows a schematic diagram depicting a time line for locking a video recording according to the present invention.

FIG. 3 shows a first schematic view of an embodiment according to the present invention.

FIG. 4 shows a second schematic view of the embodiment according to the present invention.

FIG. 5 shows a block schematic diagram of an embodiment depicting operation of the present invention.

FIG. 6 shows a block schematic diagram of another embodiment depicting operation of the present invention.

FIG. 7 shows a schematic view of a third embodiment according to the present invention.

FIG. 8 shows a schematic view of a fourth embodiment according to the present invention.

FIG. 9 shows a schematic view of an embodiment depicting the present invention when disposed in a holster.

FIG. 10 shows a schematic view of an embodiment depicting an actuating switch for an image sensor configured on the back of a gun according to the present invention.

### DETAILED DESCRIPTION OF THE PREFERRED EMBODIMENTS

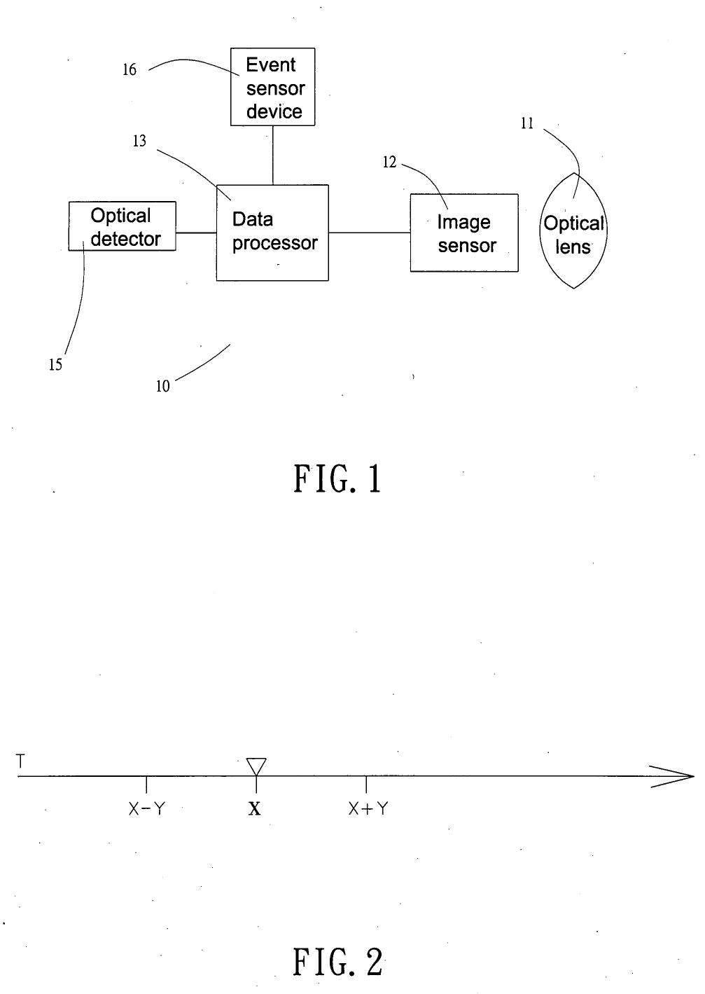

Referring to FIG. 1, which shows a gun incident recording device of the present invention, comprising an optical lens 11, an image sensor 12, a data processor 13, an optical detector 15 and an event sensor device 16, wherein the optical detector 15 of the present invention is designed to serve as an actuating device to actuate the image sensor 12, which, along with the event sensor device 16, are directly connected to the data processor 13 and entirely disposed on a shooting device 20.

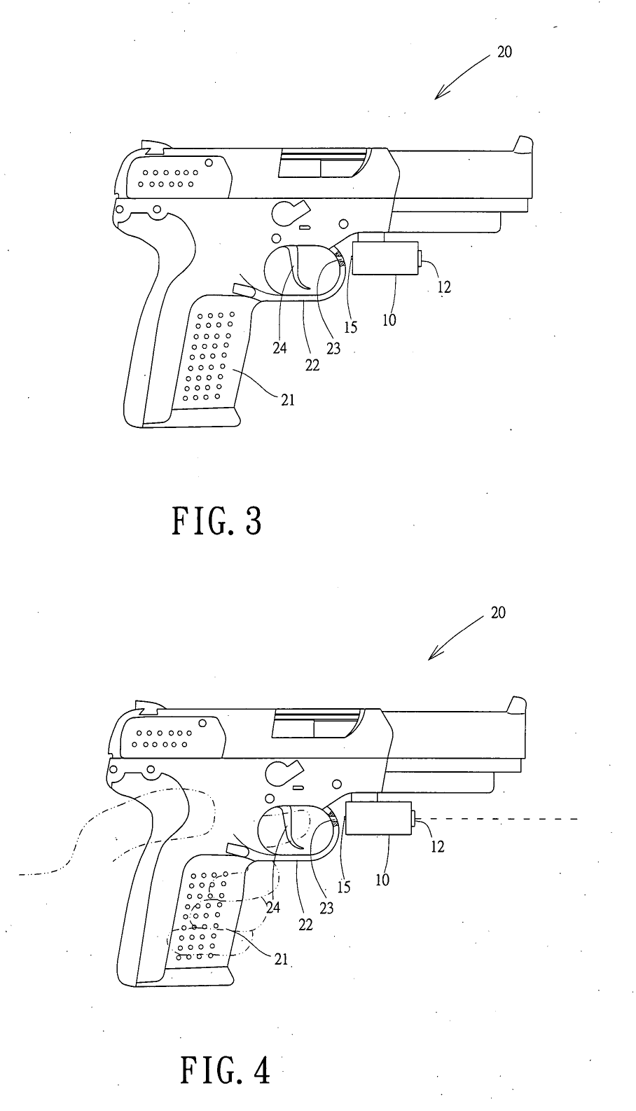

Referring to FIG. 3, which shows an embodiment of the present invention, wherein the component members are configured in a case 10 which is soldered at a position located in front of a trigger guard 22. A penetrating space 23 is configured in the trigger guard 22 at a position corresponding to a rear end of the case 10, thereby enabling the optical detector 15 located at the rear end of the case 10 to penetrate the space 23 and face a trigger 24 to detect whether or not light is being blocked, When a user wishes to use the gun, he grasps a gun handle 21 and places his fingers on the trigger 24 within the trigger guard 22, whereupon the optical detector 15 detects a foreign object intercepting the light and actuates the front end image sensor 12 to commence video recording (see FIG. 4), and the video recording is written to the data processor 13,

In practical use, the primary objective of the actuating device configuration is to detect the intention of the user to use the gun, wherein method of detection is configured according to requirements and is not confined to the aforementioned method. An embodiment of the present invention uses the optical detector 15 is the actuating device used to actuate the image sensor 12.

Because grasping the gun handle 21 is a prerequisite to using the shooting device 20, regardless of whether to return fire, shoot in self-defense, or deliberate attack, and the actuated image sensor 12 commences video recording the event pointed at by the gun user. However, the person holding the gun is not necessarily attacking, but is sometimes shot at by opposing parties and falls down. Hence, the events sensed by the event sensor device 16 includes persons firing guns, as well as persons being shot at and falling down, along with the dropping of the shooting device 20. However, the event sensor device 16 will be actuated regardless of the jerking movement of the situation, and a message is transmitted to the data processor 13, whereupon the data processor 13 locks the video recording of the event covering before and after the event occurred, thereby preventing the locked video recording from being recorded over by subsequent recording or erased.

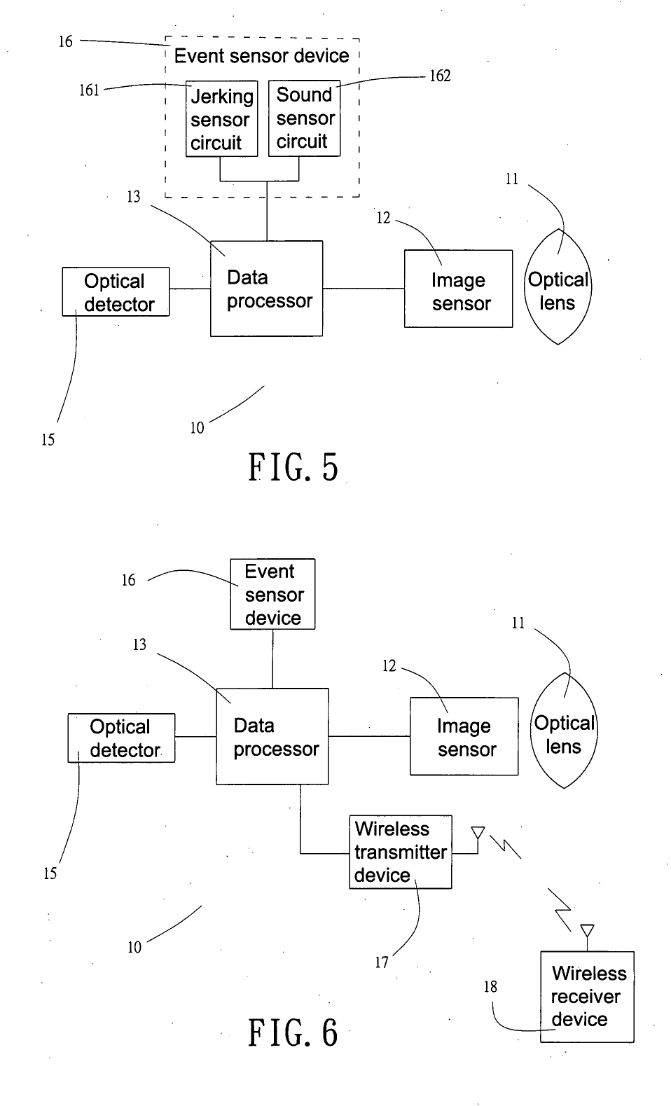

However, the aforementioned events are not necessarily the only factors involved in a shooting incident. Because of the multitude of varied situations police officers face In the line of duty and actions resulting therefrom, including shouting warnings, grappling, being assault by a criminal, seizing of the shooting device 20, and so on, thus, in order to video record all possible incidents that may occur including non-shooting and jerking movement situations, then apart from providing the event sensor device 16 with a jerking sensor function, the event sensor device 16 is also provided with a sound sensor function to cope with irregular sounds. Referring to FIG. 5, wherein the event sensor device 16 comprises a jerking sensor circuit 161 and a sound sensor circuit 162, With such a configuration, when a police officer is holding the shooting device 20 and shouting commands at a criminal, the event sensor device 16 detects the sounds from the shouted commands of the officer holding the shooting device 20 as irregular high decibel sounds and actuates the data processor 13 to lock subsequent video recording, thus retaining a video record of the complete incident showing whether or not the police officer went beyond his line of duty or if there was deliberate provocation by the criminal. Moreover, response of the jerking sensor circuit 161 is not affected by subsequent use of the shooting device 20, that is, the data processor 13 continues to function at each occurrence of a sound or jerking event according to the predetermined settings.

The aforementioned predetermined period of time for locking the period of time covering before and after a jerking event has occurred can be preset in the data processor 13. Referring to FIG. 2, wherein the predetermined period of time is specified as Y, and time when an event occurs is X, thus, after the image sensor 12 is actuated and video recording begins, then video recording time T commences, and as soon as an event occurs, the event induced device 16 senses an irregular jerking movement or sound, and the data processor 13 locks the predetermined period of time Y before and after the event occurred at the time X, that is, the data processor 13 locks the period of time between time X−Y and time X+Y. The objective of locking the predetermined period of time covering before and after an event occurs is to enable later investigation and verification of causes and effects around the time the event occurred.

Referring to FIG. 6, which shows another embodiment of the present invention, wherein, when an event is continuous, such as a gun fight or when pursuing or confronting criminals, In order for an officer in charge to understand the actual situation and give commands or provide other supervision, a wireless transmitter device 17 is configured to the present invention, thereby enabling the officer in charge to remotely actuate the wireless transmitter 17 and transmit live video of events as recorded by the image sensor 12 to a wireless receiver 18, thus providing the remotely located officer in charge with a better understanding of the situation. Moreover, when a police officer takes out the shooting device 20, supervisors are able to actuate the optical detector 15 into a normal detecting mode until it is returned to the supervisors.

When the police officer who used the shooting device 20 returns the shooting device 20, data stored in the data processor 13 can be deciphered by his supervisors or persons in charge to understand events as they occurred before, during and after using the shooting device 20, thereby enabling a judgment to be made as to whether the shooting device 20 was used because of deliberate attack from opposing parties, because of an emergency situation or whether the time for using the shooting device 20 had been truly violated. Because the target video recorded by the image sensor 12 is the opposing party pointed at by the person using the shooting device 20, thus, every movement and action of the opposing party is video recorded, thereby providing the best evidence of whether use of the shooting device 20 was appropriate or not at the time the event occurred.

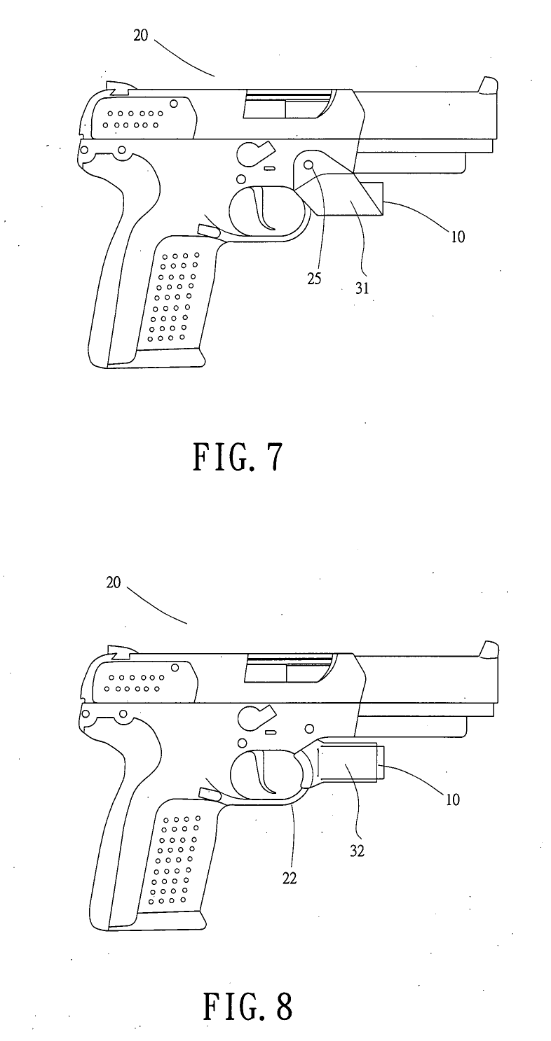

Referring to FIG. 7, which shows a method for attaching the case 10 of the present invention to the shooting device 20 wherein a U-shaped frame 31 is used to secure the case 10. Two sides of the U-shaped frame 31 extend to the body of the shooting device 20, and fixing members 25, such as insertion pins, are used to fix the two sides thereto. Referring to FIG. 8, which shows implementation of another method for attaching the case 10 of the present invention 10 to the shooting device 20 wherein a plastic jacket 32 is used to fix the case 10 to the trigger guard 22. Model of gun is taken into consideration when deciding which configuration to adopt.

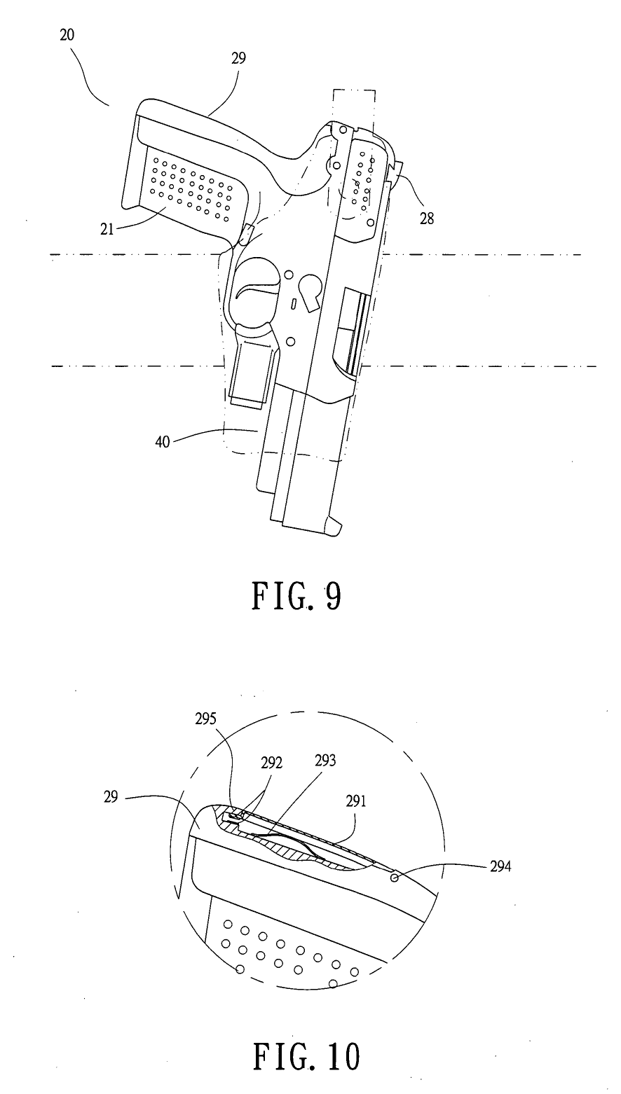

The actuating device of the gun incident recording device of the present invention can be designed to actuate the image sensor 12 upon drawing the shooting device 20 from its holster, thereby enabling commencement of video recording of an event, objective of which is to completely video record the on-scene situation after drawing the gun. Referring to FIG. 9, which depicts an embodiment of the shooting device 20 disposed in a holster 40, wherein configuration of an actuating switch is required in order for the present invention to actuate the image sensor 12 when drawing the shooting device 20 from the holster 40, such as a spring and metallic power contact strips configured interior of the gun handle 21 or a back 29 of the shooting device 20. Referring to FIG. 10, which shows an embodiment depicting the actuating device configured at the back 29 of the shooting device 20, on which is configured a flexible pressure plate 291, one end of which is provided with a pin 294, and a spring 293 (the embodiment depicted in FIG. 10 is of plate form) located beneath the pressure plate 291 is able to constantly upwardly support the pressure plate 291. Moreover, an inwardly protruding member 295 is located in the gun handle 21 to restrict flexible range of the pressure plate 291. Positive and negative poled metallic power contact strips 292 are configured at an end of the pressure plate 291 in the gun handle 21. Accordingly, grasping of the gun handle 21 of the shooting device 20 presses down on the pressure plate 291 at the back 29 of the shooting device 20, thereby activating the image sensor 12 to commence video recording. Application of such a configuration can be similarly adopted on the gun handle 21.

In conclusion, the simple structure of the gun incident recording device of the present invention is able to truly resolve disputes over use of a gun, and provide evidence of the event leading up to and after use of the gun as it actually occurred, thereby enabling the facts to become known and minimizing erroneous judgment due to insufficient evidence. The present invention is assuredly innovative and represents an advancement in prior art. Furthermore, the present invention has not been seen on the market or disclosed in inventions of other persons prior to this application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A gun incident recording device, comprising an optical lens, an image sensor, a data processor, an optical detector and an actuating device connected to the data processor and an event sensor device, all of which are disposed on a shooting device; the image sensor is configured to point in the same direction as the shooting device, and the actuating device is positioned to enable detecting when the shooting device is being mobilized, whereby, as soon as a user attempts to use the shooting device or draws the shooting device from a holster, the actuating device transmits a detection message to the data processor, whereupon the data processor instructs the image sensor to commence video recording; as soon as an even occurs involving shooting, irregular jerking movement or sound, then the event sensor device transmits a message back to the data processor, at which time the data processor locks the video recording recorded for a predetermined period of time covering before and after the event occurred, thereby preventing the locked video recording from being overwritten or erased by subsequent video data, and thus retaining a video recording for examination of the situation at the time the event occurred.

2. The gun incident recording device according to claim 1, wherein the locked video recording is provided with a function requiring deciphering in order to view.

3. The gun incident recording device according to claim 1, wherein the event sensor device is configured with a jerking sensor circuit and a sound sensor circuit.

4. The gun incident recording device according to claim 3, wherein the sound sensor circuit detects short range sound outbursts.

5. The gun incident recording device according to claim 3, wherein the jerking sensor circuit has an actuating mechanism actuated by occurrence of an irregular jerking movement.

6. The gun incident recording device according to claim 1, wherein the optical lens, the image sensor, the data processor and the actuating device and the event sensor device connected to the data processor are configured in a case and fixed to the shooting device.

7. A gun incident recording device, having a case comprising
an optical lens,
an image sensor positioned at a rear of the optical lens, which video records an on-scene situation according to instructions;
a data processor that records images video recorded by the image sensor, and which is provided with functionality to control image output and lock a video recording;
an optical detector able to detect attempts to use a trigger, and transmits messages back to the data processor;
an event sensor device, when a shooting device is trigged or there is an irregular jerking of the shooting device or a short range abnormal sound, then the event sensor device instructs the data processor to lock the specific video recording covering before and after such an event occurred;
a wireless transmitter device able to receive external message commands, and transmits an on-scene situation video recorded by the image sensor to a remote wireless receiver device for synchronous viewing thereof.

8. The gun incident recording device according to claim 7, wherein the image sensor of the case is configured to point in the same direction as the shooting device, and the optical detector is disposed in an opposite direction to the image sensor.

9. The gun incident recording device according to claim 7, wherein the event sensor device comprises a jerking sensor circuit and a sound sensor circuit.

10. A gun incident recording device, having a case comprising
an optical lens,
an image sensor positioned at a rear of the optical lens, which video records an on-scene situation according to instructions;
a data processor that receives instructions from an actuating device to actuate the image sensor to commence video recording, and records images video recorded by the image sensor, the data processor is provided with functionality to lock a video recording;
an event sensor device that transmits a message back to the data processor upon sensing an abnormal sound or jerking movement to instruct the data processor to lock the specific video recording covering before and after the event occurred;
an actuating device configured to a back (or handle) of a shooting device, wherein a flexible pressure plate is located on the back (or handle) of the shooting device, one end of the pressure plate is provided with a pin serving as a pivot and connected to the back (or handle) of the shooting device, positive and negative poled metallic power contact strips are configured at another end of the pressure plate in the back (or handle) of the shooting device, a protruding member is located on the other end of the pressure plate and is used to restrict height of the pressure plate, a spring is configured between the pressure plate and the back (or handle) of a shooting device to upwardly support the pressure plate; accordingly, grasping the handle of the shooting device causes the pressure plate to be pressed down, and the pin serving as a pivot at one end of the pressure plate enables the other end of the pressure plate to descend, thereby causing the positive and negative poled metallic power contact strips to make mutual contact, and thus activating the image sensor to commence video recording.
